(19) United States
(12) Patent Application Publication
(10) Pub. No.: US 2025/0363970 A1
(43) Pub. Date: Nov. 27, 2025

(54) DOPPLER MICROWAVE TRANSDUCER FOR MUSICAL INSTRUMENTS

(71) Applicants: Karoly Becze, Escondido, CA (US); Manav Raina, San Diego, CA (US)

(72) Inventors: Karoly Becze, Escondido, CA (US); Manav Raina, San Diego, CA (US)

(21) Appl. No.: 18/674,876

(22) Filed: May 26, 2024

(51) Int. Cl. G10H 1/00

(52) U.S. Cl. CPC G10H 1/0058; G10H 1/0083; G10H 2240/211

(57) ABSTRACT

An apparatus is disclosed, which includes a Doppler radar and its various modifications, designed to function as a musical instrument transducer. This transducer is capable of converting vibrations from the instrument into audio electronic signals. Additionally, the methods by which this transducer can be strategically placed and mounted on different types of musical instruments are also described, ensuring optimal performance and sound quality.

### CROSS-REFERENCE TO RELATED APPLICATIONS

This application claims the benefit of provisional patent application 63/504,787 filed May 29, 2023.

### PRIOR ART

U.S. Pat. No. 8,546,677 B2 October 2013 Haddad
U.S. Pat. No. 3,733,953 May 1973 Ferber
U.S. Pat. No. 4,563,931 January 1986 Siebeniker

### BACKGROUND OF THE INVENTION

This invention introduces a new method of converting musical instrument vibrations into electronic signals that potentially opens the door to new musical instrument tones by employing one or more doppler radars. The radar has a transmit signal transmitted by a transmitter antenna that is aimed at one of the resonating surfaces of the musical instrument capable of efficiently reflecting and modulating the transmitted radar signal. The reflected and modulated radar signal is then received by a receiver radar antenna. The received signal is then mixed down into the audio range using the transmitter carrier frequency tone creating an electronic replica of the instrument vibration.

The key aspects of this disclosure are the methods by which the apparatus of a Doppler radar is employed. The apparatus of the Doppler radar is formed and placed to replace traditional transducers while providing optimal conversion efficiency.

Methods have been devised that also allow mounting of such Doppler radars in instruments that in the past have not employed any transducers.

The apparatus of the employed basic Doppler radar consists of a microwave oscillator, a transmitter antenna, a microwave radome, a receiver antenna, a microwave mixer and IF amplifier.

The apparatus of the basic Doppler has been expanded where the instrument consisted of multiple independent but possibly interacting resonating surfaces. Such expanded apparatus consists of multiple independently tuned local oscillators separated by a predetermined frequency delta as well as multiple transmit and receiver antennas and mixers and their combinations thereof.

Forgoing an exhausting discussion on how the method of employing such Doppler radar for every musical instrument can be implemented, the following discussion and annexed drawings will simply illustrate the core claims of the disclosure omitting the discussion of their implementation equivalents.

### SUMMARY OF THE INVENTION

Musical instrument transducers shape their instrument sounds, due to their transfer characteristics and due to their operational principles, some adversely affect the dynamics of the resonance source. For example, magnetic string instrument pickups affect a dragging force on the resonating strings, especially if placed in proximity. Doppler radar transducers like conventional microphones exert no such dragging force letting the string vibrate freely.

The transfer characteristics of Doppler radar transducers differ from traditional transducers opening new opportunities in musical expression.

### BRIEF DESCRIPTION OF DRAWINGS

FIG. 1. Illustrates the most basic employment of a Doppler radar-based transducer in the context of a single vibrating string.

FIG. 2. illustrates a block diagram consisting of the most fundamental and required elements required to implement a system illustrated on FIG. 1.

FIG. 3. illustrates the block diagram of a system that is capable of processing vibrations from a multi-stringed instrument such as a 6-string guitar. This system employs a single transmitted frequency but used antenna arrays consisting of a single transmitter and a single receiver antenna for each string.

FIG. 4. illustrates the block diagram of a system that uses a Frequency Division Multiplex (FDM) method for a multi-stringed (multi-channel) implementation with transmission characteristics frequency shaping.

FIG. 5. Illustrates the top view of placing an array of antennas for a piano with the antennas in an upward facing position.

FIG. 6. Illustrates a 3D view of placing a transmitter and receiver antennas for percussion instruments such as a drum.

FIG. 7. Illustrates a front-view of placing a transmitter and receiver antennas for a stringed instrument such as an electric guitar.

FIG. 8. Illustrates a front-view of placing a transmitter and receiver antennas for a stringed instrument such as an electric guitar with the antennas placed in a position facing the body of the electric guitar.

### DETAILED DESCRIPTION OF THE INVENTION

The detailed description of the disclosure set forth below, in connection with the annexed drawing is intended for clarifying the method and by no means are the only configurations in which the concepts described herein can be implemented.

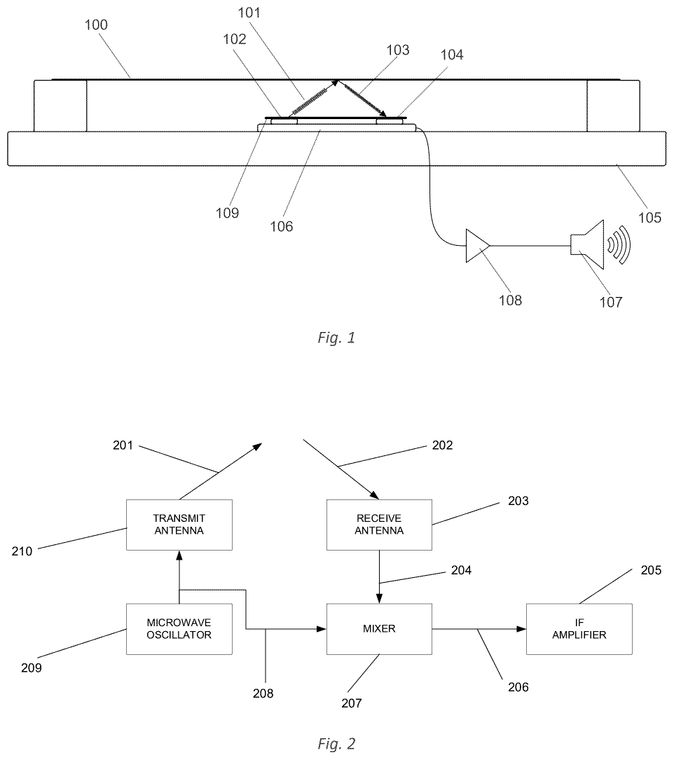

FIG. 1. Illustrates the basic principle by which the Doppler radar transducer operates. The transducer circuits are mounted on a substrate carrier plate 106 such as a printed circuit board (PCB). The Transmit antenna 102 emits carrier wave (CW) 101 microwave signals in the millimeter wave range aimed at a vibrating surface such as a drum skin, cymbal, or string 100. The reflected radio wave 103 is modulated by the vibrating surface 100 according to Doppler's equation. A radome transparent to the emitted microwave frequency is placed to protect apparatus from physical damage 109. The Doppler's equation assuming a stationary instrument:

$${f}_{r} = {f}_{t} ( \frac{c}{c - v} )$$

Where:
fₜ is the frequency of the transmitted microwave signal
fᵣ is the frequency of the received microwave signal
c is the speed of light i.e. the speed of propagation for the microwave signal
v is the speed at which the string or instrument surface vibrates

After mixing the received signal with the transmitter local oscillator frequency:

$${f}_{IF} = {f}_{t} ( \frac{v}{c} )$$

Where:
f_{IF} is the demodulated audio signal frequency which is proportional to the speed of the vibrating surface speed v.
This signal can be further amplified and processed using traditional methods. The sound produced in a conventional speaker after amplification resembles the instrument sound at high fidelity.

FIG. 2. illustrates a block diagram consisting of the most fundamental and required elements of a basic Doppler radar system. Such a system can convert vibrations from a single vibrating surface such as a drum or a single string. Microwave oscillator 209 produces a single carrier wave microwave signal which is split in two ways. A portion of the signal will be transmitted 201 at the transmit antenna 210 while the other portion 208 will be used to mix down the received signal 204 from the receiver antenna 203 into the audio frequency range 206 that can be further amplified by an IF amplifier 205.

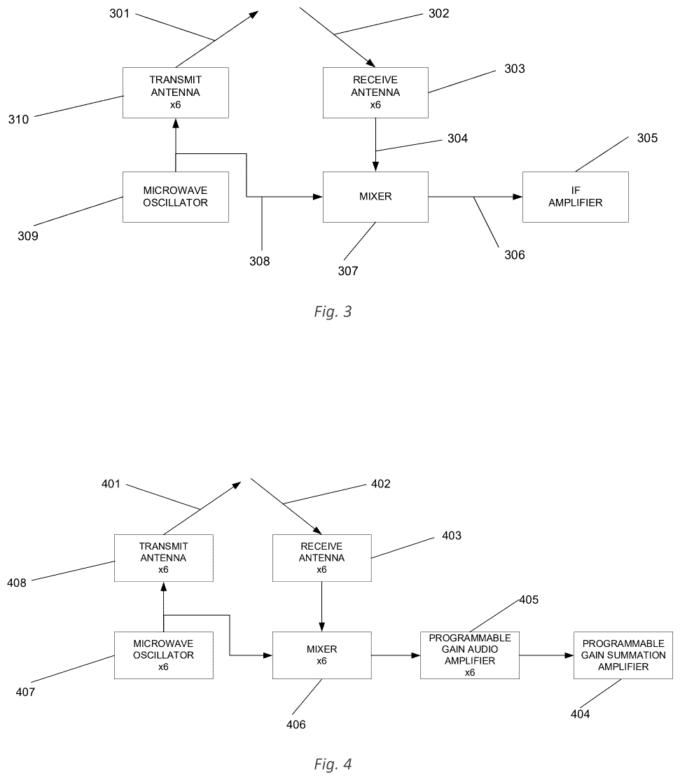

For instruments where there are distinct vibrating surfaces in close proximity of each other such a multi-string instrument for example a guitar or a piano, FIG. 3. illustrates the block diagram of a system that would still employ single microwave oscillator common for all, or a group of vibrating surfaces. An implementation such as this would use an antenna array with separate transmitter and receiver feed networks. The antenna patterns of the antennas need to be balanced such that the array factor for each vibrating surface is equal. This may present implementation issues and design difficulties.

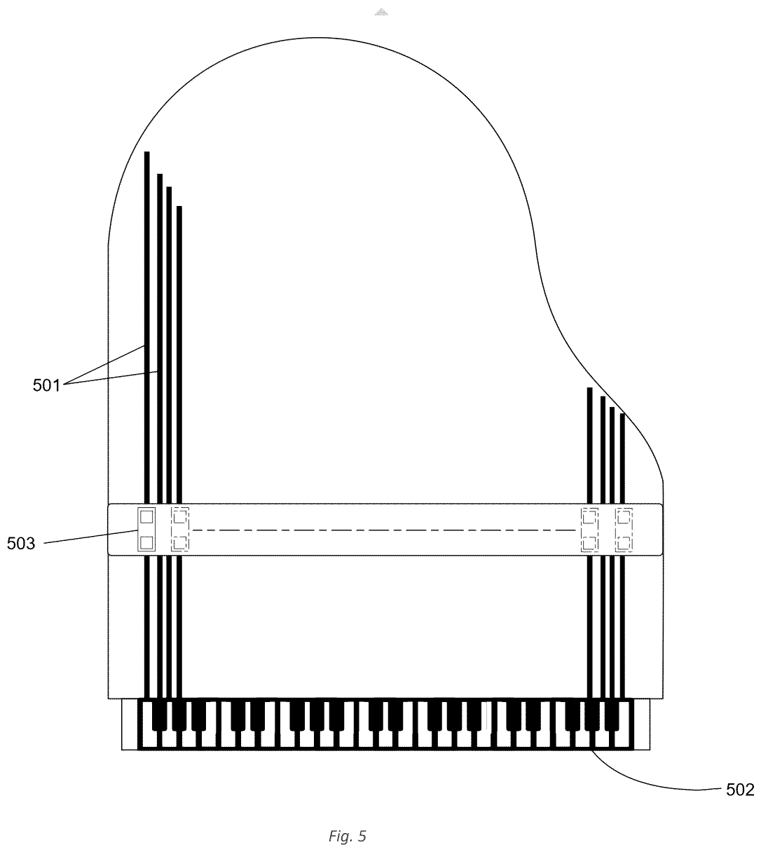

FIG. 4. illustrates the block diagram of a system that uses a Frequency Division Multiplex (FDM) method for vibrating surfaces that are in proximity to each other. The microwave oscillators 407 are tuned to frequencies that are at least twice the maximum audio (IF) frequency apart to ensure orthogonality and hence the gain differences from the antenna array will be eliminated. In addition, crosstalk between neighboring transducers is eliminated. Furthermore, the channels can be individually shaped for gain 405, hence it provides additional flexibility to shape the transducer frequency response by applying user input.

FIG. 5. Illustrates how an array of Doppler radar transducers could be employed for a piano. The figure illustrates transmit and receive antennas 503 placed above each group of piano strings 501. Employing transducers over vibrating strings in a piano is not the only way to convert vibrations. Doppler transducers can be placed over any vibrating surface and the sounds of multiple transducers can be mixed.

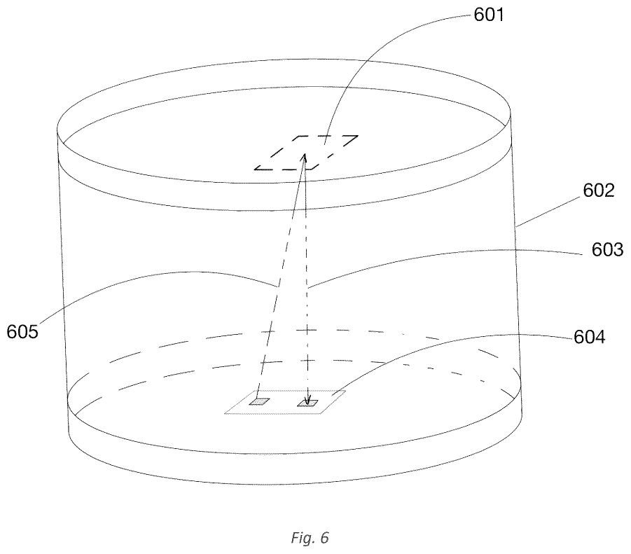

FIG. 6. Illustrates how a Doppler radar transducer 604 could be employed for percussion instruments such as a drum. The transducer 604 emits the radio wave and hits the vibrating drum surface which may be covered on its reverse side with a microwave reflective material 601 to improve the signal to noise ratio of the reflected signal 603. The reflected Doppler wave is received by the transducer 604 and converted to an electronic audio signal. The placement of the transducer is critical in shaping the frequency response of the sound and may be placed off center of the batter head or aimed at the shell 602 of the drum to obtain a variation of the tone.

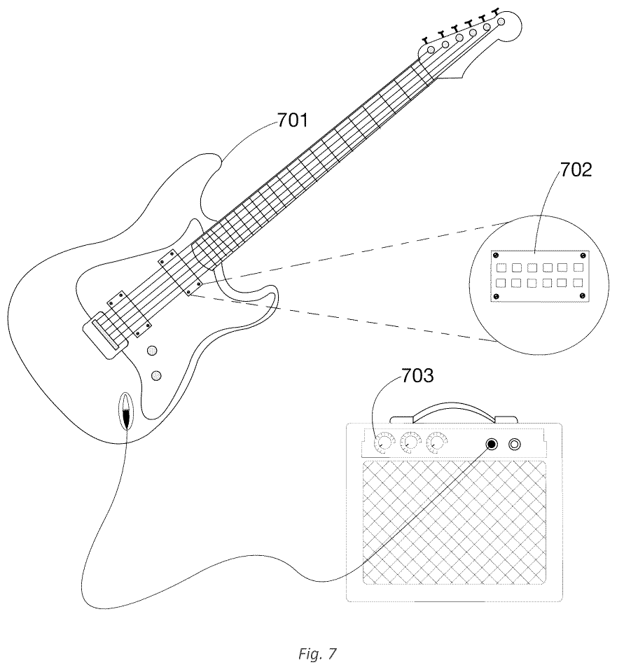

FIG. 7. Illustrates how a Doppler radar transducer 702 could be employed on a string instrument such as an electric guitar 701. In this diagram a conventional magnetic pickup is replaced by a Doppler radar pickup. One transmitter and one receiver pair of antennas are placed under each guitar string. The output of the Doppler radar transducer can be amplified using a traditional guitar amplifier 703.

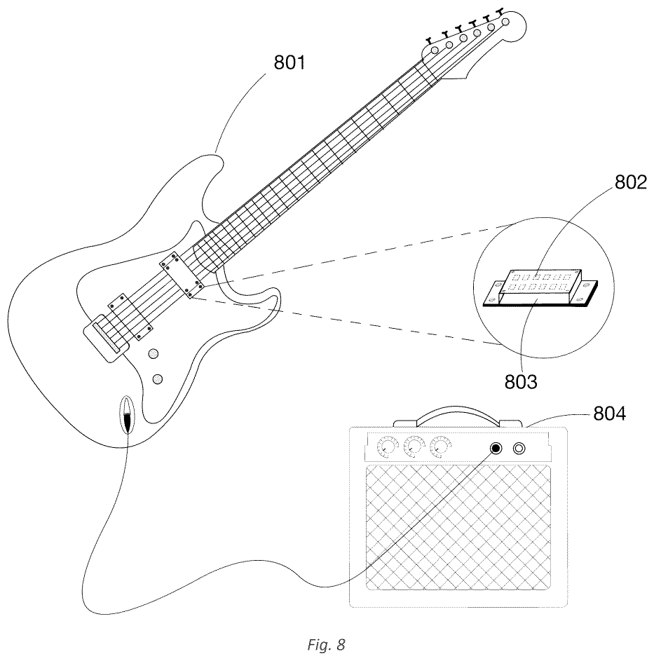

FIG. 8. Illustrates an improved version of the Doppler radar mount described on FIG. 7. An unintended side effect of using Doppler radar on a guitar instrument 801 is the reflection of the microwave received by the player's moving picking hand. To overcome this problem the Doppler radar transducer 803 is placed over the instrument strings in an upside-down position, shielding the player's moving hand. The Doppler radar antenna elements 802 transmit and receive the radio waves towards and from the guitar body 801 processing reflected waves both from the instrument strings as well as the vibrating body 801 of the instrument. The reflected signal is free from the unintended reflections from the player's moving hands.

1. An apparatus, comprising:
a microwave transmitter antenna;
a microwave receiver antenna;
a microwave local oscillator;
a microwave receiver mixer;
an audio low-pass filter;
and an audio amplifier.

2. The apparatus of claim 1, wherein multiple transmit and multiple receive antennas are employed. The transmit and receive antennas are to be located at optimal locations to maximize the power of the reflected wave from resonating musical instrument surfaces.

3. The apparatus of claim 2, wherein multiple local oscillators are employed separated by at least twice the bandwidth of the audio bandwidth of the sound generated by the musical instrument.

4. The apparatus of claim 2, wherein a set of transmitter and receiver antennas are dedicated for a string for string instruments.

5. The apparatus of claim 4, where the transmitter and receiver antennas are effectively operating in a 3-dimensional space where no player movement occurs.

6. The apparatus of claim 1, where the musical instrument resonating surface is covered with a material aiding microwave reception.

7. The apparatus of claim 2, wherein a summation circuit is added to produce a single sensor output.

8. The apparatus of claim 2, wherein an equalization circuit is added to enable gain adjustments for every receiver chain.

9. The apparatus of claim 8 where the parameters of the receiver circuit are controlled remotely over a wireless communication link.
